(19) United States
(12) Patent Application Publication
(10) Pub. No.: US 2025/0239003 A1
(43) Pub. Date: Jul. 24, 2025

(54) THREE DIMENSIONAL OBJECT GENERATION, AND IMAGE GENERATION THEREFROM

(71) Applicant: Lemon Inc., Grand Cayman (KY)

(72) Inventors: Kejie Li, Los Angeles, CA (US); Peng Wang, Los Angeles, CA (US); Yichun Shi, Los Angeles, CA (US)

(21) Appl. No.: 18/417,700

(22) Filed: Jan. 19, 2024

(51) Int. Cl. G06T 15/20; G06N 3/0499; G06T 15/08

(52) U.S. Cl. CPC G06T 15/20; G06N 3/0499; G06T 15/08

(57) ABSTRACT

A method of generating a three-dimensional (3D) object includes generating, with a multi-view stereo (MVS) neural reconstruction network, a feature volume from images that include multiple viewpoints of a subject, and applying score distillation sampling (SDS) fine-tuning to the feature volume resulting in a 3D object of the subject. A non-volatile computer-readable medium with instructions configured to cause performance of operations of said method. A system for providing a 3D object including an input to receive a text prompt from a user that corresponds to a subject. The system including a 3D object engine configured to generate, using a multi-view diffusion model, one or more images of the subject from different viewpoints, generate, with a MVS reconstruction neural network, a feature volume from the images of the subject, and apply SDS fine-tuning to the feature volume resulting in the 3D object of the subject.

### FIELD

This disclosure relates to generation of a three dimensional (3D) object. More particularly, this disclosure relates to generation of a three-dimension object from input of text and/or two dimensional media.

### BACKGROUND

Image generation is implemented on a growing scale, based on both open-source and proprietary solutions. The generation of 3D models from text and/or two dimensional (2D) media (e.g., 2D image(s) of a subject) is increasing popular for generating images of the subject of the text/2D media (e.g., image(s) from different viewpoints of the subject of the 2D image(s)). For example, image generators can receive a natural language descriptor and produce an image that matches the input descriptor, as a result of the image generators having been trained on both descriptors and images procured from various sources.

### SUMMARY

In an embodiment, a method is directed to generating a three-dimensional (3D) object. The method includes generating, with a multi-view stereo (MVS) neural reconstruction network, a feature volume from images of a subject. The images of the subject include multiple viewpoints of the subject. The method also includes applying score distillation sampling (SDS) fine-tuning to the feature volume resulting in a 3D object of the subject.

In an embodiment, a non-volatile computer-readable medium has computer-executable instructions stored thereon. The computer-executable instructions when executed cause one or more processors to perform operations. The operations include generating, with a MVS neural reconstruction network, a feature volume from images of a subject. The images of the subject include multiple viewpoints of the subject. The operations also include applying SDS fine-tuning to the feature volume resulting in a 3D object of the subject.

In an embodiment, a system for providing a 3D object includes an input to receive a text prompt from a user and a 3D object engine. The text prompt includes a subject. The 3D object is configured to generate, using a multi-view diffusion model, one or more images of the subject from different viewpoints, to generate, with a MVS reconstruction neural network, a feature volume from the images of the subject, and to apply SDS fine-tuning to the feature volume resulting in the 3D object of the subject. The 3D object engine also configured to generate an output image of the subject by rendering the 3D object from a viewpoint, and to output the output image of the subject.

### DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Non-limiting and non-exhaustive descriptions are described with reference to the following drawings. The components in the figures are not necessarily to scale, emphasis instead being placed upon illustrating principles. In the detailed description that follows, embodiments are described as illustrations only since various changes and modifications may become apparent to those skilled in the art from the following detailed description.

FIG. 1 show a schematic diagram of an embodiment of a system for generating a 3D object.

FIG. 2 shows a schematic overview of an embodiment of an implementation of 3D object generation.

FIG. 3A shows a schematic diagram of an embodiment of a process flow for generating a 3D object.

FIGS. 3B-3D show images generated in the process flow of FIG. 3A, according to an embodiment.

FIG. 4 is a block flow diagram of an embodiment of a method of generating a 3D object.

FIG. 5 is a schematic structural diagram of an embodiment of a computer system.

Like numbers represent like features.

### DETAILED DESCRIPTION

In the following detailed description, particular embodiments of the present disclosure are described herein with reference to the accompanying drawings, which form a part of the description. In this description, as well as in the drawings, like-referenced numbers represent elements that may perform the same, similar, or equivalent functions, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It is to be readily understood that the aspects of the present disclosure, as generally described herein and illustrated in the drawings, may be arranged, substituted, combined, separated, and designed in a wide variety of different configurations, all of which are explicitly contemplated herein.

Additionally, portions of the present disclosure may be described herein in terms of functional block components and various processing steps. It should be appreciated that such functional blocks may be realized by any number of hardware and/or software components configured to perform the specified functions.

A “generator” or “engine”, as referenced herein, may refer to a type of software, firmware, hardware, or any combination thereof, that facilitates generation of source code or markup to produce elements that begin another process. In addition, or alternatively, a generator or engine may facilitate automated processes, in which various software elements interact to produce an intended product, whether physical or virtual based on natural language descriptions, inputs, or other prompts. In accordance with known machine learning technologies, the generators disclosed, recited, and/or suggested herein may be trained in accordance with either unimodal or multimodal training models, unless described otherwise.

A “diffusion model”, as referenced herein, refer to a class of machine learning models that generate new data based on training data. More particularly, diffusion models add noise to training data and then reverse the noising process to recover the data, thus generating coherent images from noise. Even more particularly, a neural network is trained to de-noise images blurred with Gaussian noise by learning to reverse the diffusion process.

Multilayer perceptron or MLP may refer to a feedforward artificial neural network that is to generate a set of outputs from a set of inputs. As described, recited, or otherwise referenced herein, an MLP may be characterized by several layers of input nodes connected as a directed graph between the input and output layers. Such layers are known in the art for use in rendering (e.g., volume rendering) of a feature volume.

Rendering, volume rendering, or neural rendering may refer to a class of deep image and video generation approaches that enable explicit or implicit control of scene properties such as illumination or lighting, camera parameters, poses, geometry, appearance, shapes, semantic structure, etc. As described, recited, or otherwise referenced herein, rendering, volume rendering, or neural rendering may refer to an operation or function, based on deep neural networks and physics engines, for creating novel images from a feature volume/3D object. In accordance with the non-limiting embodiments described and recited herein, functions of rendering, volume rendering, and neural rendering may be implemented by a renderer, neural renderer, or a MLP.

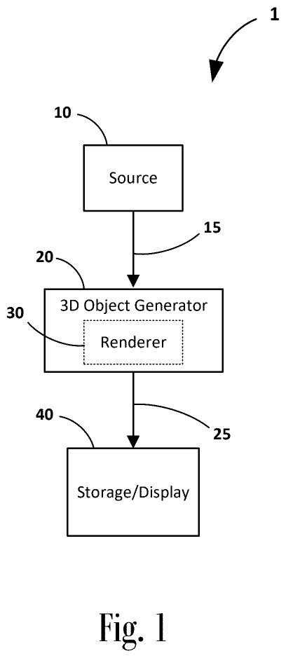

FIG. 1 illustrates an embodiment of a system 1 in which a 3D object is generated, arranged in accordance with at least some embodiments described herein.

The system 1 may include a source 10 and a 3D object generator 20. In an example embodiment, the source 10 may be an electronic device (e.g., 2000 of FIG. 5, etc.) including but not limited to, a smartphone, a tablet computer, a laptop computer, a desk computer, and/or any other suitable electronic device. In another example embodiment, the source 10 may be a storage, a database, a file, or the like (e.g., 2040 in FIG. 5). In an embodiment, the input may be provided by a user via an input of the electronic device (e.g., 2030 in FIG. 5) or remotely to the electronic device (e.g., via 2040 in FIG. 5).

The source 10 may provide input 15 to the 3D object generator 20. In an example embodiment, the 3D object generator 20 may be a function, an operation, an action, an algorithm, an application, or the like that is implemented, designed, stored, executed, performed, or otherwise hosted in an electronic device (e.g., 2000 in FIG. 5, etc.) including but not limited to a server, a cloud network, a smartphone, a tablet computer, a laptop computer, a desk computer, and/or any other suitable electronic device. The input 15 may be text, one or more images, or the like. The input 15 may be provided by a user via the source 10 (e.g., a text prompt entered into an electronic device, a portion of said text prompt, etc.). In an embodiment, the input 15 may include text, one or more images, etc. stored in the source 10.

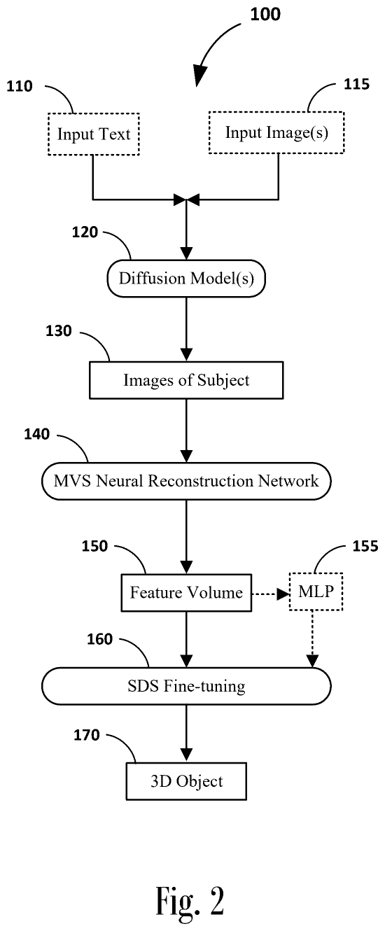

The 3D object generator 20 receives input 15 from the source 10 and generates an output 25 based on the input 15. The 3D object generator 20 generates a 3D object of a subject corresponding to the input 15 (e.g., descriptions of FIGS. 2-5). The 3D object generator 20 may include a renderer 30. The renderer 30 can generate one or more output images by (volume) rendering the 3D object from one or more viewpoints. The output 25 may include the generated 3D object and/or the output image(s) generated by the 3D object generator. The generated 3D object and/or output image(s) may be stored in, displayed by, and/or sent to a device 40. In some embodiments, the device 40 may be a storage device (e.g., 2040 in FIG. 5), an output/display device (e.g., 2035 in FIG. 5), and/or an electronic device (e.g., 2000 in FIG. 5).

FIG. 2 shows a schematic overview 100 of an implementation of 3D object generation, in accordance with at least some embodiments. As shown in FIG. 2, the overview 100 includes input text 110, input image(s) 115, diffusion model(s) 120, images of subject 130, multi-view stereo (MVS) neural reconstruction network 140, feature volume 150, (score distillation sampling) SDS fine-tuning 160, and three-dimensional (3D) object. For example, the overview 100 may be an embodiment of a 3D object generator (e.g., 3D object generator in FIG. 1). Half Dash lines are included in the Figures to indicate features that may be different and/or excluded in different embodiments. However, it should also be appreciated that features in the Figures shown in solid lines may also be different in other embodiments.

Input text 110 and/or input image(s) 115 are input into diffusion model(s) 120 to generate images of the subject 130. The images of the subject 130 are input into the MVS Neural Reconstruction Network 140 that outputs a feature volume 150 of the subject. SDS fine-tuning 160 is then applied to the feature volume 150 resulting in a 3D Object 170 of the subject.

The input (input text 110 and/or input image(s) 115) correspond with a subject to be generated as a 3D object in the 3D object generation. For example, input text 110 and/or input image(s) 115 may be received from a user. In an embodiment, the input text 110 may be a prompt from a user or a portion of a prompt from a user. In an embodiment, the input image(s) 115 include one or more (individual) images of the subject or one or more images from a video of subject. The images 130 may include the one or more of the input image(s) 115, one or more images generated from the input text 110 by the diffusion model(s) 120, one or more images generated from the input image(s) 115 by the diffusion model(s) 120, or a combination thereof.

Diffusion model(s) 120 may be a single diffusion model or a plurality of diffusion models. In some embodiments, the diffusion model(s) 120 may be a plurality of sequential diffusion models (e.g., an output of one diffusion model is the input into next diffusion model, or the like). The diffusion model(s) 120 are configured/trained to generate, from input text/images, images of a subject (e.g., the subject corresponding to the input text/images) from different viewpoints. For example, the input image(s) may include one or more viewpoints of a subject, and the diffusion model(s) may generate images with new/additional viewpoints of the subject from the input image(s). The diffusion model(s) 120 may be configured to generate images from the input text. The diffusion model(s) may be configured to generate additional images from the generated images. The diffusion model(s) are discussed in more detail below.

The angle between views and viewpoints are discussed herein with respect to a horizontal plane (e.g., angle relative between views/viewpoints in a downward view of the subject). However, it should be appreciated the images may be generated having views/viewpoints that are that show the subject along a different plane of a subject (e.g., a top view/viewpoint, views disposed there-between, etc.).

The images of the subject 130 include multiple viewpoints of the subject. In an embodiment, the images of the subject 130 include at least four viewpoints of the subject (e.g., images 130 include at least four images showing the subject from at least four (different) viewpoints). In an embodiment, the images of the subject 130 include at least eight viewpoints of the subject. In an embodiment, the images of the subject 130 include at least 12 viewpoints of the subject. In an embodiment, the images of the subject 130 include at least 16 viewpoints of the subject.

The MVS Neural Reconstruction Network 140 is designed, trained, or otherwise configured to generate the feature volume 150 from the images 130. The feature volume 150 is a 3D feature volume corresponding to the object. For example, the MVS Neural Reconstruction Network 140 is configured to lift the 2D images 130 to form the 3D feature volume 150. In an embodiment, the MVS Neural Reconstruction Network 140 is trained on a general dataset (e.g., not limited to a particular subject category, to utilizing images of particular viewpoints, etc.). In some embodiments, an implementation of the 3D object generation in FIG. 2 made be configured for use on a specific type or category subject. It should be appreciated that in such embodiments, the MVS Neural Reconstruction Network 140 may be trained based on a specific data set of said specific type/category (category of text prompt).

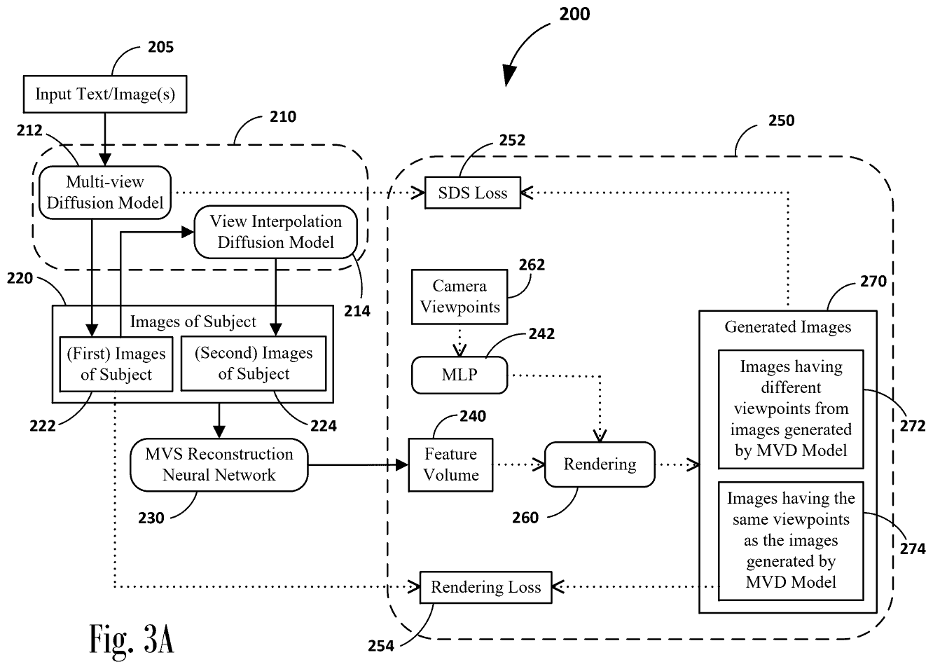

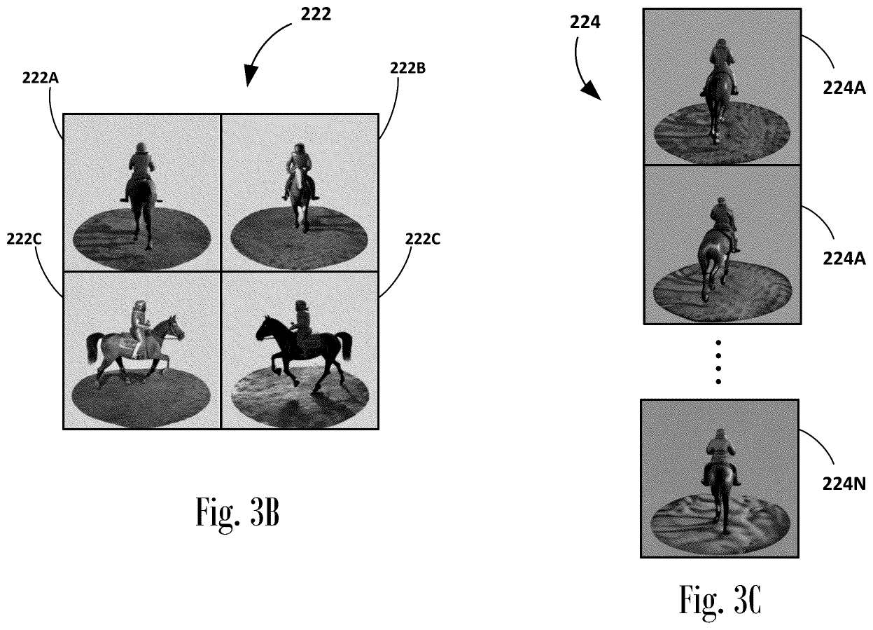

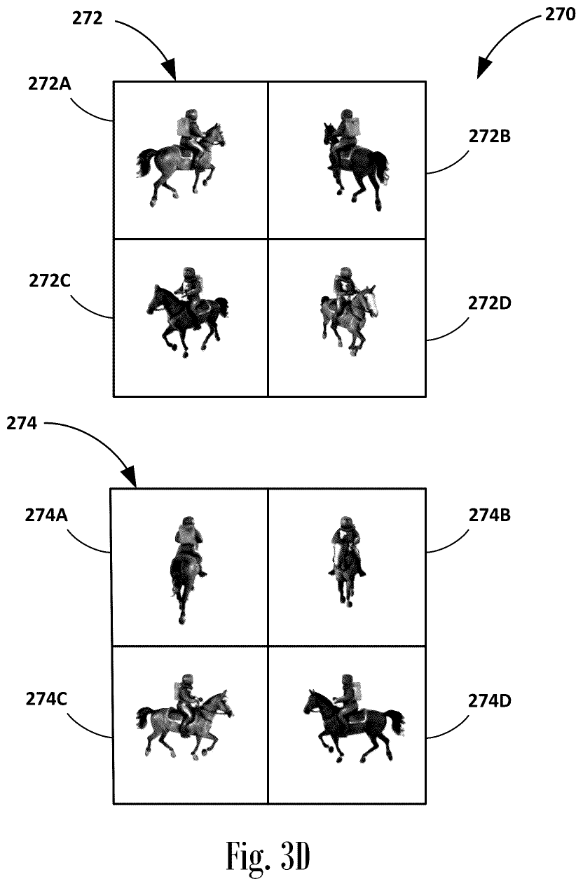

In an embodiment, a MVS Neural Reconstruction Network 140 may be trained utilizing training data images. For example, the training data images may be generated by a diffusion model (e.g., MVD model 212 in FIG. 3A) from a set of known inputs (e.g., text prompts). The MVS Reconstruction Neural Network 140 may be trained with rendering loss and SDS fine-tuning. In embodiment, the MVS Reconstruction Neural Network 140 is trained with rendering loss for a first portion of the training (e.g., a beginning portion of the training), and then trained with SDS fine-tuning for a second portion of the training (e.g., a later portion of the training). In one non-limiting example, rendering loss was used for a first third of the training and SDS fine-tuning was utilized for the remaining two thirds of the training. In an embodiment, the rendering loss may be annealed (e.g., color rendering loss is annealed from 1000 to 0) and/or the SDS fine-tuning may have a limited maximum timestep as discussed herein.

As shown in FIG. 2, a multi-layer perceptron (MLP) 155 may be utilized to render the feature volume 150 (e.g., neural volume rendering of the feature volume 150). For example, the MLP 155 can be configured to determine coloring of the function volume 150 at different viewpoints. For a desired viewpoint, a 3D location of said viewpoint can be input into the MLP 155, and the MLP 155 can output colors for the feature volume 150 when viewed from said viewpoint. For example, a 3D location for a desired viewpoint of the feature volume 150 is input into the MLP 155, and the MLP 155 outputs a density and/or an albedo at each point (e.g., for each voxel) in the feature volume 150. The density and/or albedo can then be used to determine color of each pixel of an image of the feature volume 150 from said viewpoint.

In one non-limiting embodiment, for an arbitrary 3D location (x), a MLP (Fe) is used to determine the corresponding volume density (o) and albedo (a) conditioned on the feature volume 150, as shown in Formula (1) below. In Formula (1), f is the feature trilinerally interpolated from the feature volume 150 at position x. Accordingly, a color image (e.g., RGB image) of the object may be determined at a novel viewing point. For example, color of a pixel c may be determined from the Formulas (2) and (3) below. In Formulas (2) and (3), Ati is the distance between adjacent sampled points, and Ti is the accumulated transmittance. It should be appreciated that MLP in an embodiment may be configured in a different manner as known in the art for volume rendering.

$$σ , α = {F}_{θ} ( x , f ) \qquad ( 1 )$$

$$c = {\sum }_{i}^{K} {T}_{i} ( ( 1 - exp ( - σΔ {t}_{i} ) ) {α}_{i} \qquad ( 2 )$$

$${T}_{i} = exp ( {\sum }_{j}^{i - 1} {σ}_{j} * Δ {t}_{j} ) \qquad ( 3 )$$

The SDS fine-tuning 160 is applied to the feature volume 150 resulting in the 3D object 170 of the subject. For example, the SDS fine-tuning 160 refines the feature volume 150, and the resulting refined feature volume is the 3D object 170 of the subject. In an embodiment, the SDS fine-tuning 160 is applied to both the feature volume 150 and the MLP 155 (e.g., the SDS fine-tuning 160 is applied to the combination of the feature volume 150 and the MLP 155). The SDS fine-tuning 160 can be configured to jointly optimize the feature volume 150 and the parameters of the MLP 155. The SDS fine-tuning 160 enhances the geometry and appearance of the produced 3D object 170. For example, the SDS fine-tuning 160 can be provided to remove blurriness that occurs in textures of the feature volume 150 generated by a MVS reconstruction neutral network 140.

In previous conventional 3D generation methods, SDS has been utilized to directly distill a 2D diffusion model. However, the SDS-based iterative optimization process is time consuming such that the 3D generation can take a relatively longer time. For example, the generation of a 3D object from an input text in the conventional generation methods, the 3D generation can take about 1.5 hours. In the 3D generation described herein (e.g., as implanted in FIG. 2), a 3D object of at least a similar quality to said conventional 3D generation method was generated in at or about 10 minutes in some embodiments. In an embodiment, the 3D object generation described herein is configured to generate a 3D object from an input (e.g., input text 110) in at or about 1 hour or less. In an embodiment, the 3d object generation may be configured to generate a 3D object from an input (e.g., input text 110) in at or about 30 minutes or less. In an embodiment, the 3d object generation may be configured to generate a 3D object from an input (e.g., input text 110) in at or about 20 minutes or less. In an embodiment, the 3d object generation may be configured to generate a 3D object from an input (e.g., input text 110) in at or about 15 minutes or less.

FIG. 3A is an embodiment of an example process flow 200 for generating a 3D object. FIGS. 3B-3D show example embodiments of images 222, 224, 270 in the process flow 200. Images 222, 224, 270 as shown in FIGS. 3B-3D are black-and-white images. It should be appreciated that the output images 222, 224, 270 in embodiments may be black-and-white images, grayscale images, RGB images, or the like. In an embodiment, the output images are colored images (e.g., non-grayscale colored, RGB colored, or the like). As depicted, process flow 200 includes operations or sub-processes executed by various components of system 1, as shown and described in connection with FIGS. 1 and 2. However, process flow 200 is not limited to such components and processes, as obvious modifications may be made by re-ordering two or more of the sub-processes described here, eliminating at least one of the sub-processes, adding further sub-processes, substituting components, or even having various components assuming sub-processing roles accorded to other components in the following description.

As shown in FIG. 3A, an input text/image(s) 205 is provided to the process flow 200. The input text/image(s) 250 can be the input text 110 and/or the input image(s) 115 in FIG. 2. For simplicity the following description for the process flow 200 is generally described below for an embodiment in which the input 205 is input text. However, it should be appreciated that the input 205 may be other media in other embodiments (e.g., input image(s), etc.).

The input text 205 corresponds to a subject. In one non-limiting example, the images in FIGS. 3B-3D for an input text 205 that is “an astronaut riding a horse”. It should be appreciated that the input text 205 may be different in other embodiments. In an embodiment, the processing flow 200 may be designed, trained, or otherwise configured to not be limited to a specific type or subject category for the input 205.

The text 205 is input into diffusion models 210, and the diffusion models output images of the subject 220. For example, the images 220 may be the images of the subject 130 in FIG. 2. For example, the images 220 include multiple viewpoints of the subject as similarly discussed in FIG. 2. In an embodiment, the average angle between each adjacent pair of viewpoints of the images 220 may be less than at or about 35°. In an embodiment, the average angle between each adjacent pair of viewpoints of the images 220 may be less than at or about 30°. In an embodiment, the average angle between each adjacent pair of viewpoints of the images 220 may be less than at or about 25°. In an embodiment, the average angle between each adjacent pair of viewpoints of the images 220 may be less than at or about 22.5°. In the illustrated embodiment, the images 220 include 16 images having equally spaced apart viewpoints of the subject (e.g., 360°/16 images=22.5° between each adjacent pair of viewpoints).

In the illustrated embodiment, the diffusion models 210 include a multi-view diffusion (MVD) model 212 and a view interpolation diffusion (VID) model 214 to generate the images 214. The MVD model 212 is designed, trained, or otherwise configured to receive the input (e.g., input text, input image(s), etc.) that corresponds to a subject, and to generate images showing the subject from multiple viewpoints. The VID model 214 is designed, trained, or otherwise configured to receive images showing a subject from multiple viewpoints, and to generate images showing the subject from additional viewpoints. For example, in one non-limiting example, the VID model 214 may propagate four image viewpoints into 16 image viewpoints. The VID model 214 is configured to generate, based on the input images, images that include viewpoints between the viewpoints of the input images (e.g., images 222 generated by the MVD model 212 showing views of the subject at 0°, 90°, 180°, and 270°, and VID model 214 generates additional images 224 showing the subject at one or more views between 0° and 90°, one or more views between 90° and 180°, one or more views between 180° and 270°, and one or more views between 270° and) 0°/360°.

The input text 205 is input into a multi-view diffusion (MVD) model 212, and the MVD model 212 generates (first) images 222 of the subject from multiple viewpoints based on the input text 205. The first images 222 includes multiple viewpoints of the subject as shown in FIG. 3B. The first images 222 may show the subject from at least four viewpoints. In another embodiment, the first images 222 may show the subject from at least three viewpoints. For example, first images 222 include an image 222A with a rear view of the subject, an image 222B with a front view of the subject, an image 222C with a right view of the subject, and an image 222D with a left view of the subject. In another embodiment, the first images 222 may show the subject from at least two viewpoints.

The images 222 generated by the MVD model 212 are input into the VID model 214, and the VID model generates (second) images 224 of the subject from additional viewpoints based on the images 222 generated by the MVD model 212. The second images 224 includes multiple viewpoints of the subject different form the viewpoints of the first images 222 (e.g., first images 222 at first viewpoints, second images 224 at second viewpoints different from each of the first viewpoints). As shown in FIG. 3A, the images 220 generated from the input 205 include the first images 222 and the second images 224. In another embodiment, the VID model 214 may be designed, trained, or otherwise configured to generate all of the images 220 (e.g., VID model 214 generates both images at the new viewpoints and re-generates images at the old viewpoints). In another embodiment, the MVD model 212 may be designed, trained, or otherwise configured to generate all of the images (e.g., MVD model 212, based on the input 205, generates images at the desired number of (different) viewpoints, MVD model 212 generates images 220 of the subject at 16 viewpoints, or the like).

The images 220 of the subject are input into a MVS reconstruction neural network 230, and the MVS reconstruction neural network 230 generates a feature volume 240 based on the images 220. For example, the MVS reconstruction neural network 230 is designed, trained, or otherwise configured to lift the multiple-view images 220 of the subject to a 3D feature volume 240 that defines the geometry and appearance information of 3D positions. In one non-limiting example, the MVS reconstruction neural network 230 can an extract 2D feature map from each input image 220, and then aggregates the 2D feature maps to a 3D feature volume 240. A sparse 3D CNN may be used to aggregate neighboring 3D features. It should be appreciated that MVS reconstruction neural networks 230 are known in the art and may be modified to have different features/implementations than described above.

The feature volume 240 is configured to be rendered 260 (e.g., volume rendered, neural volume rendered) using an MLP 242. The MLP 242 can be the MLP 155 in FIG. 2. The feature volume 240 is rendered using the MLP 242 input with a selected camera viewpoint 262 to generate an image of the subject from said viewpoint.

SSD fine-tuning 250 is applied to the feature volume 240. In an embodiment, the SSD fine-tuning 250 is applied to in combination to both the feature volume 240 and the MLP 242 for the feature volume 240. Processing features of the SSD fine-tuning 250 are shown in dotted arrows in FIG. 3A. The SSD fine-tuning 250 includes applying SSD to the feature volume 240 to improve/optimize the feature volume 240. The applied SSD fine-tuning 250 is guided by one or more of SDS loss 252 and rendering loss 254. In the embodiment illustrated in FIG. 3A, the SSD fine-tuning 250 is guided by SDS loss 252 and rendering loss 254.

The SSD fine-tuning 250 includes generating images 270 of the subject by rendering the feature volume 240 at various camera viewpoints 262. The generated images 270 can include images 272 and images 274. The images 272 have viewpoints different from viewpoints of the images generated by the MVD model 212 (e.g., images 272 have viewpoints different from any of the viewpoints of the (first) images 222). The images 274 have viewpoints that are the same as the viewpoints generated by the MVD model 212 (e.g., images 272 and images 222 have the same viewpoints). FIG. 3D show one non-limiting example of the generated images 270. For example, the images 274 in FIG. 3D (e.g., image 274A, image 274B, image 274C, image 274D) have viewpoints that match the viewpoints of the images 222 in FIG. 3B. For example, the images 272 in FIG. 3D (e.g., image 272A, image 272B, image 272C, image 272D) each have a viewpoint that is different from any of the viewpoints of the images 222 in FIG. 3B.

SDS loss 252 is based on comparing the images 270 to images generated by the MVD model 212. SDS loss 252 is based on comparing the images 270 to corresponding estimated denoised images generated by the MVD 212 (e.g., each image 270 is compared to an estimated denoised image generated by the MVD having the same viewpoint, SDS loss 252 corresponds to a degree of difference between images 270 and the corresponding estimated denoised images generated by the MVD model). Rendering loss 254 is based on comparing the images 274 to the corresponding images 222 previously generated by the MVD model 212 (e.g., rendering loss 254 corresponds to a degree of difference between each image 274 to its corresponding image 222, rendering loss 254 correspond to a degree of difference between each corresponding pair of images 274 and images 222 that have the same viewpoint).

In an embodiment, the SDS fine-tuning 250 utilizes one or more of a truncated and an annealed timestep schedule for the MVD model 222 (e.g., the MVD model 222 as utilized in determining SDS loss 254 has a truncated and/or annealed timestep schedule). In one embodiment, the SDS fine-tuning 250 utilizes a truncated and annealed timestep schedule for the MVD model 222. In one embodiment, the timestep scheduling for the SSD fine-tuning has a maximum timestep of at or about 700 steps. In another embodiment, the timestep scheduling for the SSD fine-tuning 250 has a maximum timestep of at or about 600 steps. In another embodiment, the SSD fine-tuning 250 has a maximum timestep of at or about 500 steps.

In an embodiment, the rendering loss 254 is an annealed rendering loss. The rendering loss 254 is annealed over the iterations of the SDS fine-tuning 250. In one non-limiting example, the rendering loss may be annealed linearly across the iterations of the SDS fine-tuning 250.

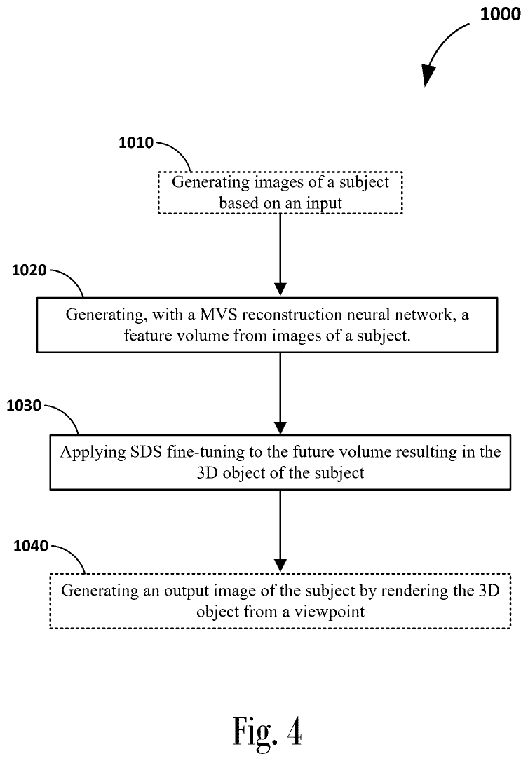

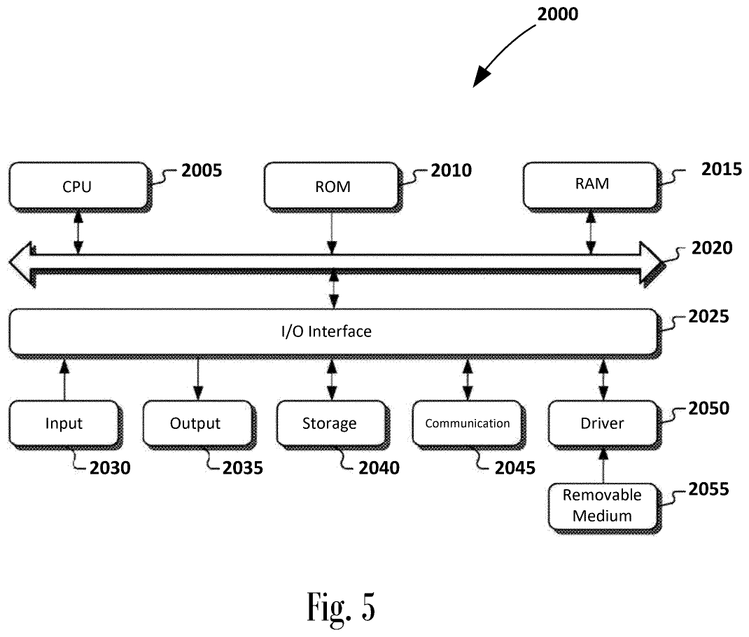

FIG. 4 illustrates an example embodiment of a method 1000 of generating a 3D object. For example, the method 1000 may be employed by the system 1 in FIG. 1 (e.g., employed by the 3D object generator in FIG. 1). For example, the method 1000 in some embodiments may be employed to implement the overview 100 in FIG. 2 and/or to implement the process flow 200 in FIG. 3. It should be appreciated that the method 1000 as shown in FIG. 4 and described below in other embodiments may be modified to have features as described for the system 1 in FIG. 1, for the implementation of 3D object generation in FIG. 2, and/or for the process flow 200 in FIG. 3. Method 1000 may include various operations, functions, or actions as illustrated by one or more of blocks 1010, 1020, 1020, 1030. These various operations, functions, or actions may, for example, correspond to software, program code, or program instructions executable by a processor that causes the functions to be performed. Method 1000 may begin at block 1010.

At block 1010, images of a subject are generated based on an input (e.g., image input, text input, input 15 in FIG. 1, or the like). For example, in the illustrated embodiment of FIG. 2, input 110, 115 is input into diffusion models 120, and the diffusion model(s) 120 generate images of a subject corresponding to the input 110, 115. For example, in the illustrated embodiment of FIG. 3A, input text/image(s) 205 are input into the MVD model 212, and the MVD model 212 and the VID model 214 generate images 220 of the subject. The method 1000 then proceeds to block 1020.

At block 1020, a feature volume is generated by a MVS reconstruction neural network from the images of the subject. For example, in the illustrated embodiment of FIG. 2, MVS reconstruction neural network generates the feature volume 150 from the images 130 of the subject. For example, in the illustrated embodiment of FIG. 3A, the MVS reconstruction neural network 230 generates the feature volume 240 from the images 220 of the subject. The method 1000 then proceeds to 1030.

At block 1030, SDS fine-tuning is applied to the future volume. The result of the application of the SDS fine-tuning to the feature volume is a 3D object of the subject (e.g., the SDS fine-tuned future volume is the 3D object of the subject). For example, in the illustrated embodiment of FIG. 2, SDS fine-tuning 160 is applied to the feature volume 150 resulting in the 3D object 170 (e.g., SDS fine-tuning 160 is applied to the combination of the feature volume 150 and the MLP 155 for the feature volume 150). For example, in the illustrated embodiment of FIG. 3A, SDS fine-tuning 250 is applied to the feature volume 240. The SDS fine-tuning of the future volume can be guided by SDS loss (e.g., SDS loss 252 in FIG. 3A) and rendering loss (e.g., rendering loss 254 in FIG. 3A). The method 1000 may then proceed to block 1040.

At block 1040, an output image is generated by rendering the 3D object from a viewpoint. For example, in the illustrated embodiment of FIG. 1, output 25 is generated by the renderer 30. For example, in the illustrated embodiment of FIG. 1, output 25 can be an image generated by the renderer 30 rendering a 3D object of a subject (corresponding to the input 15) generated by the 3D object generator 20. For example, with reference to the illustrated embodiment of FIG. 2, the output image may be generated by rendering 3D object from a desired viewpoint (e.g., volume rendering, volume rendering utilizing a MLP for the feature volume/3D object) in a similar manner as discussed for the rendering 260 of the feature volume 240 in FIG. 3A (e.g., rendering 260 being applied to the feature volume 240 using the MLP 242 after being SSD fine-tuned 250 in which an input to the SSD fine-tuned MLP 242 is the desired viewpoint).

It should be appreciated that in an embodiment, the method 1000 as described above and shown in FIG. 4 may be designed, modified, and/or otherwise configured to have feature(s) as discussed for the system 1 in FIG. 1, the implementation of 3D object generation in FIG. 2, and/or the process flow 200 in FIG. 3A. In an embodiment, a method, 3D engine, may be directed to the 3D object generation at the SDS fine-tuning as described herein (e.g., block 1030 in FIG. 4) and/or generating of an output image therefrom (e.g., block 1040 in FIG. 4).

FIG. 5 is a schematic structural diagram of an example computer system 2000 applicable to implementing an electronic device (e.g., system 1, source 10, 3D object generator 20, and/or display/storage 30 shown in FIG. 1), arranged in accordance with at least some embodiments described herein. It is to be understood that the computer system 2000 shown in FIG. 5 is provided for illustration only instead of limiting the functions and applications of the embodiments described herein.

Computer-readable instructions may, for example, be executed by a processor of a device, as referenced herein, having a network element and/or any other device corresponding thereto, particularly as applicable to the applications and/or programs described above corresponding to system 1 in FIG. 1, implementation of the overview 100 in FIG. 2, process flow 200 in FIG. 3A, method 1000 in FIG. 4, and the like.

As depicted, the computer system 2000 may include a central processing unit (CPU) 2005. The CPU 2005 may perform various operations and processing based on programs stored in a read-only memory (ROM) 2010 or programs loaded from a storage device 2040 to a random-access memory (RAM) 2015. The RAM 2015 may also store various data and programs required for operations of the system 2000. The CPU 2005, the ROM 2010, and the RAM 2015 may be connected to each other via a bus 2020. An input/output (I/O) interface 2025 may also be connected to the bus 2020.

The components connected to the I/O interface 2025 may further include an input device 2030 including a keyboard, a mouse, a digital pen, a drawing pad, or the like; an output device 2035 including a display such as a liquid crystal display, a speaker, or the like; a storage device 2040 including a hard disk or the like; and a communication device 2045 including a network interface card such as a LAN card, a modem, or the like.

The communication device 2045 may perform communication processing via a network such as the Internet, a WAN, a LAN, a LIN, a cloud, etc. In an example embodiment, a driver 2050 may also be connected to the I/O interface 2050. A removable medium 2055 such as a magnetic disk, an optical disk, a magneto-optical disk, a semiconductor memory, or the like may be mounted on the driver 2050 as desired, such that a computer program read from the removable medium 2055 may be installed in the storage device 2040.

It is to be understood that the processes described with reference to the flowcharts and/or processes described in other figures may be implemented as computer software programs or in hardware. The computer program product may include a computer program stored in a computer readable non-volatile medium. The computer program includes program codes for performing the method shown in the flowcharts.

In this embodiment, the computer program may be downloaded and installed from the network via the communication device 2045, and/or may be installed from the removable medium 2055. The computer program, when being executed by the central processing unit (CPU) 2005, can implement the above functions specified in the methods in the embodiments disclosed herein.

It is to be understood that the disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory, electrically erasable programmable read-only memory, and flash memory devices; magnetic disks, e.g., internal hard disks or removable disks; magneto optical disks; and compact disc read-only memory and digital video disc read-only memory disks. The processor and the memory can be supplemented by, or incorporated in, special purpose logic circuitry.

It is to be understood that different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

### Aspects:

Any of Aspects 1-13 may be combined with any of Aspects 14-24, and any of Aspects 14-18 may be combined with any of Aspects 19-24.

Aspect 1: A method of generating a three-dimensional (3D) object, comprising:
generating, with a multi-view stereo (MVS) neural reconstruction network, a feature volume from images of a subject, the images of the subject including multiple viewpoints of the subject; and
applying score distillation sampling (SDS) fine-tuning to the feature volume resulting in a 3D object of the subject.

Aspect 2: The method of Aspect 1, wherein the SDS fine-tuning is guided by one or more of:
rendering loss based on comparison of the images of the subject to images generated from rendering of the 3D object from the multiple viewpoints, and
SDS loss based on comparison of images generated from rendering of the 3D object at viewpoints different from the multiple viewpoints to corresponding images expected from a multi-view diffusion model that generates one of the images of the subject.

Aspect 3: The method of Aspect 2, wherein the SDS fine-tuning is guided by both the rendering loss and the SDS loss.

Aspect 4: The method of any one of Aspects 1-3, wherein the images correspond to at least four viewpoints of the subject.

Aspect 5: The method of Aspects 1-4, further comprising:
generating the images of the subject based on input text, wherein the input text corresponds with the subject.

Aspect 6: The method of Aspect 5, wherein the images of the subject are generated based on the input text using a multi-view diffusion model.

Aspect 7: The method of Aspect 6, wherein the generating of the images of the subject based on the input text includes:
the multi-view diffusion model generating first images of the subject based on the input text, and
a view interpolation diffusion model generating second images of the subject based on the first images of the subject, the images of the subject include the first images and the second images of the subject.

Aspect 8: The method of Aspect 7, wherein the second images each have a viewpoint that bisects a respective pair of viewpoints of the first images.

Aspect 9: The method of any one of Aspects 1-8, further comprising:
generating an output image of the subject by rendering the 3D object from a viewpoint.

Aspect 10: The method of Aspect 9, wherein the output image is rendered using a multi-layer preceptor of volume density of the feature volume.

Aspect 11: The method of Aspect 10, wherein the applying of the SDS fine-tuning to the feature volume includes applying the SDS fine-tuning to both the feature volume and the multi-layer preceptor of volume density of the feature volume.

Aspect 12: The method of any one of Aspect 1-11, wherein the method is configured to generate the 3D object in at or less than 1 hour.

Aspect 13: The method of any one of Aspects 1-12, wherein the MVS neural reconstruction network is trained on a generic database of objects.

Aspect 14: A non-volatile computer-readable medium having computer-executable instructions stored thereon that, when executed, cause one or more processors to perform operations comprising:
generating, with a multi-view stereo (MVS) neural reconstruction network, a feature volume from images of a subject, the images of the subject including multiple viewpoints of the subject; and
applying score distillation sampling (SDS) fine-tuning to the feature volume resulting in a 3D object of the subject.

Aspect 15. The non-volatile computer-readable medium of Aspect 14, wherein the SDS fine-tuning is guided by one or more of:
rendering loss based on comparison of the images of the subject to images generated from rendering of the 3D object from the multiple viewpoints, and
SDS loss based on comparison of images generated from rendering of the 3D object at viewpoints different from the multiple viewpoints to corresponding images expected from a multi-view diffusion model that generates one of the images of the subject.

Aspect 16: The non-volatile computer-readable medium of Aspect 15, wherein the SDS fine-tuning is guided by both the rendering loss and the SDS loss.

Aspect 17: The non-volatile computer-readable medium of any one of Aspects 14-16, the operations further comprising:
generating, using at least a multi-view diffusion model, the images of the subject based on input text, wherein the input text describes the subject.

Aspect 18: The non-volatile computer-readable medium of any one of Aspects 14-17, the operations further comprising:
generating an output image of the subject by rendering the 3D object from a viewpoint.

Aspect 19: A system for providing a three-dimensional (3D) object, comprising:
an input to receive a text prompt from a user, the text prompt including a subject,
a 3D object engine configured to:
   generate, using a multi-view diffusion model, one or more images of the subject including multiple viewpoints of the subject,
   generate, with a multi-view stereo (MVS) neural reconstruction network, a feature volume from the images of the subject, and
   apply score distillation sampling (SDS) fine-tuning to the feature volume resulting in the 3D object of the subject,
   generate an output image of the subject by rendering the 3D object from a viewpoint, and
   output the output image of the subject.

Aspect 20. The system of Aspect 19, wherein the SDS fine-tuning is guided by one or more of:
rendering loss based on comparison to the images of the subject, and
SDS loss based on comparison to a multi-view diffusion model that generated at least one of the images of the subject.

Aspect 21. A system for providing a three-dimensional (3D) object, comprising:
a 3D object engine configured to:
   apply score distillation sampling (SDS) fine-tuning to a feature volume of a subject resulting in the 3D object of the subject, the feature volume being generated from images of the subject that include multiple viewpoints of the subject.

Aspect 22. The system of Aspect 21, wherein the 3D object engine is further configured to:
generate, with a multi-view stereo (MVS) neural reconstruction network, the feature volume from the images of the subject.

Aspect 23. The system of any one of Aspects 21 and 22, wherein the 3D object engine is further configured to:
generate, using one or more diffusion models, the images of the subject from one or more of input text and one or more input images of the subject.

Aspect 24. The system of any one of Aspects 21-23, wherein the 3D object engine is further configured to:
generate an output image of the subject by rendering the 3D object from a viewpoint, and output the output image of the subject.

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components. In an embodiment, “connected” and “connecting” as described herein can refer to being “directly connected” and “directly connecting”.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

What is claimed is:

1. A method of generating a three-dimensional (3D) object, comprising:
generating, with a multi-view stereo (MVS) neural reconstruction network, a feature volume from images of a subject, the images of the subject including multiple viewpoints of the subject; and
applying score distillation sampling (SDS) fine-tuning to the feature volume resulting in a 3D object of the subject.

2. The method of claim 1, wherein the SDS fine-tuning is guided by one or more of:
rendering loss based on comparison of the images of the subject to images generated from rending the 3D object at the multiple viewpoints, and
SDS loss based on comparison of images generated from rendering of the 3D object at viewpoints different from the multiple viewpoints to corresponding images expected from a multi-view diffusion model that generates one of the images of the subject.

3. The method of claim 2, wherein the SDS fine-tuning is guided by both the rendering loss and the SDS loss.

4. The method of claim 1, wherein the images correspond to at least four viewpoints of the subject.

5. The method of claim 1, further comprising:
generating the images of the subject based on input text, wherein the input text corresponds with the subject.

6. The method of claim 5, wherein the images of the subject are generated based on the input text using a multi-view diffusion model.

7. The method of claim 6, wherein the generating of the images of the subject based on the input text includes:
the multi-view diffusion model generating first images of the subject based on the input text, and
a view interpolation diffusion model generating second images of the subject based on the first images of the subject, the images of the subject include the first images and the second images of the subject.

8. The method of claim 7, wherein the second images each have a viewpoint that bisects a respective pair of viewpoints of the first images.

9. The method of claim 1, further comprising:
generating an output image of the subject by rendering the 3D object from a viewpoint.

10. The method of claim 9, wherein the output image is rendered using a multi-layer preceptor for the feature volume.

11. The method of claim 10, wherein the applying of the SDS fine-tuning to the feature volume includes applying the SDS fine-tuning to both the feature volume and the multi-layer preceptor for the feature volume.

12. The method of claim 10, wherein the method is configured to generate the 3D object in at or less than 1 hour.

13. The method of claim 10, wherein the MVS neural reconstruction network is trained on a generic database of objects.

14. A non-volatile computer-readable medium having computer-executable instructions stored thereon that, when executed, cause one or more processors to perform operations comprising:
generating, with a multi-view stereo (MVS) neural reconstruction network, a feature volume from images of a subject, the images of the subject including multiple viewpoints of the subject; and
applying score distillation sampling (SDS) fine-tuning to the feature volume resulting in a 3D object of the subject.

15. The non-volatile computer-readable medium of claim 14, wherein the SDS fine-tuning is guided by one or more of:
rendering loss based on comparison to the images of the subject, and
SDS loss based on comparison to a multi-view diffusion model that generated at least one of the images of the subject.

16. The non-volatile computer-readable medium of claim 15, wherein the SDS fine-tuning is guided by both the rendering loss and the SDS loss.

17. The non-volatile computer-readable medium of claim 14, the operations further comprising:
generating, using at least a multi-view diffusion model, the images of the subject based on input text, wherein the input text describes the subject.

18. The non-volatile computer-readable medium of claim 14, the operations further comprising:
generating an output image of the subject by rendering the 3D object from a viewpoint.

19. A system for providing a three-dimensional (3D) object, comprising:
an input to receive a text prompt from a user, the text prompt including a subject, a 3D object engine configured to:
generate, using a multi-view diffusion model, one or more images of the subject including multiple viewpoints of the subject,
generate, with a multi-view stereo (MVS) reconstruction neural network, a feature volume from the images of the subject, and
apply score distillation sampling (SDS) fine-tuning to the feature volume resulting in the 3D object of the subject,
generate an output image of the subject by rendering the 3D object from a viewpoint, and
output the output image of the subject.

20. The system of claim 19, wherein the SDS fine-tuning is guided by one or more of:
rendering loss based on comparison to the images of the subject, and
SDS loss based on comparison to a multi-view diffusion model that generated at least one of the images of the subject.
